(19) United States
(12) Patent Application Publication
(10) Pub. No.: US 2015/0062206 A1
(43) Pub. Date: Mar. 5, 2015

(54) ADJUSTING A DISPLAY BASED ON A BRACE OF A COMPUTING DEVICE

(71) Applicant: LENOVO (Singapore) PTE, LTD., New Tech Park (SG)

(72) Inventor: Christopher Miles Osborne, Cary, NC (US)

(73) Assignee: LENOVO (Singapore) PTE, LTD., New Tech Park (SG)

(21) Appl. No.: 14/015,525

(22) Filed: Aug. 30, 2013

(51) Int. Cl. G09G 5/00

(52) U.S. Cl. CPC G09G 5/005
USPC 345/698

(57) ABSTRACT

For integrating multiple different touch based inputs, a method is disclosed that includes detecting a pressure at a screen pressure module, enabling a first touch module based on the pressure exceeding a pressure threshold value, and integrating input from a second touch module and the first touch module, the input from the first touch module and the second touch module being concurrently received.

### BACKGROUND

1. Field

The subject matter disclosed herein relates to using a mobile computing device and more particularly relates to adjusting a display for the device based on a brace of the device.

2. Description of the Related Art

In general, mobile computing devices may be configured with a screen. As technology advances, a larger screen may be preferred by a user. However, mobile computing devices typically include a bezel around the outside of the device which allows a user to brace or brace the device. In other devices, a bezel can be useful to provide a location for connectors, cameras, haptics, buttons, or other electronics. The size of a bezel has typically been determined based on a determined width of a thumb which allows a user to brace the computing device without activating a touchscreen for the device.

As technology advances, the need for a bezel has increasingly diminished. Although a bezel may provide a point to brace, may protect the display from a drop or provide a location for other electronics, a bezel for a mobile computing device limits the amount of space available for a screen.

### BRIEF SUMMARY

An apparatus for adjusting a display based on a brace of a computing device is disclosed. A method and computer program product also perform the functions of the apparatus. In one embodiment, an apparatus includes a processor, a screen, and a grip module configured to detect a brace status. In another embodiment, the apparatus includes an analysis module configured to determine if the brace status matches a brace pattern. In a further embodiment, the apparatus includes a display module configured to alter a portion of the screen used for display based on the determined brace pattern.

In one embodiment, the apparatus further includes a motion module configured to detect a motion of the apparatus, the grip module further configured to detect a brace status based on the detected motion. In another embodiment, the apparatus further includes an orientation module, the orientation module configured to detect an orientation of the apparatus, the grip module further configured to detect a brace status based on the detected orientation.

In one embodiment, the brace status includes a grip of the apparatus. In another embodiment, the brace status matches a plurality of brace patterns. In another embodiment, a brace status does not match a brace pattern, and the display module is further configured to increase the portion of the screen used for display, based on the brace status. In one embodiment, the display module alters the aspect ratio of the display, based on the portion of the screen used for display.

In another embodiment, the brace status includes a detected brace of the apparatus, the display module further configured to decrease a portion of the screen used for display, based on the brace status. In one embodiment, the display module disables a left edge of the screen, and disables a right edge of the screen, and the display module adjusts the display to fit inside the disabled edges.

A method is disclosed that adjusts a display based on a brace of a computing device. In one embodiment, the method includes detecting a brace of a computing device, the brace comprising touching a portion of the screen for the computing device. In another embodiment, the method includes determining if the brace matches one of a set of brace patterns. In a further embodiment, the method alters a displayable portion of a screen based on the matched brace pattern.

In one embodiment, the method includes increasing a portion of a screen being used for display in response to determining that the screen is not being touched. In another embodiment, the altering a displayable portion of the screen includes decreasing the size of the display in response to a determined brace pattern, the display not using a portion of the screen that is being touched. In a further embodiment, the decreasing the size of the display comprises disabling a top portion of the screen and disabling a bottom portion of the screen.

In one embodiment, the altering further comprises altering a displayable portion of a screen based on a configuration parameter. In another embodiment, the detecting the brace includes detecting one of a motion, or an orientation for the computing device, the determining comprising determining if the brace matches a brace pattern, based on one of the detected motion and the detected orientation.

A program product comprising a computer readable storage medium storing machine readable code executable by a processor to perform operations is disclosed. In one embodiment, the operations include detecting a brace of a computing device, the brace comprising touching a portion of the screen for the computing device. In another embodiment, the operations include determining if the brace matches one of a set of brace patterns. In a further embodiment, the operations include altering a portion of a screen being used for display based on the matched brace pattern.

In one embodiment, the operations include increasing a portion of a screen being used for display in response to determining that the screen is no longer being touched. In another embodiment, the altering a portion of the screen includes decreasing the size of the display to no longer use a portion of the screen that is being touched. In a further embodiment, the altering a portion of the screen comprises disabling a top portion of the screen, disabling a bottom portion of the screen, and adjusting an aspect ratio for the display based on a usable portion of the screen. In one embodiment, the determining if the brace matches one of a set of brace patterns includes detecting one of a motion or an orientation of the computing device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a an apparatus for adjusting a display based on a brace of a computing device;

FIG. 2 is another schematic block diagram illustrating one embodiment of an apparatus for adjusting a display based on a brace of a computing device;

FIG. 3 is a schematic block diagram illustrating one embodiment of a system for adjusting a display based on a brace of a computing device;

FIG. 4 is an illustration depicting one embodiment of a display;

FIG. 5 is an illustration depicting one embodiment of a display after adjustment;

FIG. 6 is an illustration depicting one embodiment of a display after adjustment;

FIG. 7 is an illustration depicting one embodiment of a device in tent mode;

FIG. 8 is an illustration depicting one embodiment of a display having been decreased in size;

FIG. 9 is an illustration depicting one embodiment of a display having been decreased in size in response to a persistent touch;

FIG. 10 is an illustration depicting one embodiment of a computing device including haptics;

FIG. 11 is schematic flow chart diagram illustrating one embodiment of a method for adjusting a display based on a brace of a computing device; and

FIG. 12 is another schematic flow chart diagram illustrating one embodiment of a method for adjusting a display based on a brace of a computing device.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices, and may exist, at least partially, merely as electronic signals on a system or network. Where a module or portions of a module are implemented in software, the software portions are stored on one or more computer readable storage devices.

Any combination of one or more computer readable medium may be utilized. The computer readable medium may be a machine readable signal medium or a storage device. The computer readable medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wireline, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by machine readable code. These machine readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The machine readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The machine readable code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and machine readable code. Descriptions of Figures may refer to elements described in previous Figures, like numbers referring to like elements. In order to address the current state of the art, the present application disclose several embodiments of a method, system, and apparatus for adjusting a display based on a brace of a computing device.

A computing device, as used herein, means at least a device capable of performing logic operations. A computing device may include a process, memory, screen, or the like. For example, a computing device, may be a personal computer, a handheld computer, a mobile device, a cellular phone, a tablet computer, a laptop computer, or other, or the like. A computing device, as described herein, may also include one or more touch sensors, motion sensors, orientation sensors, or the like.

A computing device may be braced in various ways. As used herein, a brace may include a user of the computing device holding the computing device. In another embodiment, a brace includes a stand configured to support the computing device. In another embodiment, a brace includes a user grasping the device in a hand, wherein one or more finger touch the screen. In another embodiment, a brace may include a thumb, or similar, touching a corner of the screen. One skilled in the art may recognize a variety of other ways in which a computing device may be braced, held, supported, or the like. In another embodiment, a brace includes any combination of the aforementioned braces, or similar, or other.

A computing device may also include a brace status. As used herein, a brace status may include the computing device being braced in various ways as previously described. In one embodiment, a brace status may include the computing device not being currently braced. In one embodiment, a brace status may include the computing device resting on top of something. In another embodiment, a brace status may include the computing device sitting on a table, or the like. In one embodiment, a brace status may include the computing device being held by a stand, clip, or other, or the like. In one embodiment, a brace status may include the computing device being in a certain physical configuration. A physical configuration may include, resting flat, being in tent mode, substantially vertical, upright, rotated, or the like. In one embodiment, a brace status may include the computing device being release such that there is no current active brace. A brace status may include braces from a thumb on opposing sides. A brace status may include opposing fingers on a top and bottom of a screen. A brace status may include moving, or experiencing significant acceleration. A brace status may include rotating at an angular velocity. A brace status may include falling. A brace status may include several fingers on one edge of the screen. Edges of a screen may be top, bottom, left, right, or other. In another embodiment, a screen may be circular wherein one edge may be described using a beginning and ending angle. An edge may include the sides of a computing devices, however, an edge may also include a side portion of another surface of a computing device. For example, an edge may include the very edge of another surface of a computing device, and areas of the surface within 10 centimeters of the very edge of the surface. In other embodiment, an edge may include more or less surface area of a surface of a computing device. Of course, other screen configurations may be used, and other brace patterns exist, but this disclosure is not limited in this regard.

A computing device, in one embodiment, may include a screen. A screen substantially comprises the electronics responsible for generating a visual output. A screen may include a wide variety of display technologies including, but not limited to, digital light processing, cathode ray tube, liquid crystal, plasma, light emitting diode, organic light emitting diode, or other, or the like, as one skilled in the art may appreciate.

A screen may generate a display. In one embodiment, a generated display may substantially include the entire screen. In another embodiment, a generated display may include a portion of the screen. In other embodiment, a generated display may include multiple different display regions. In another embodiment, a generated display may be at a certain aspect ratio.

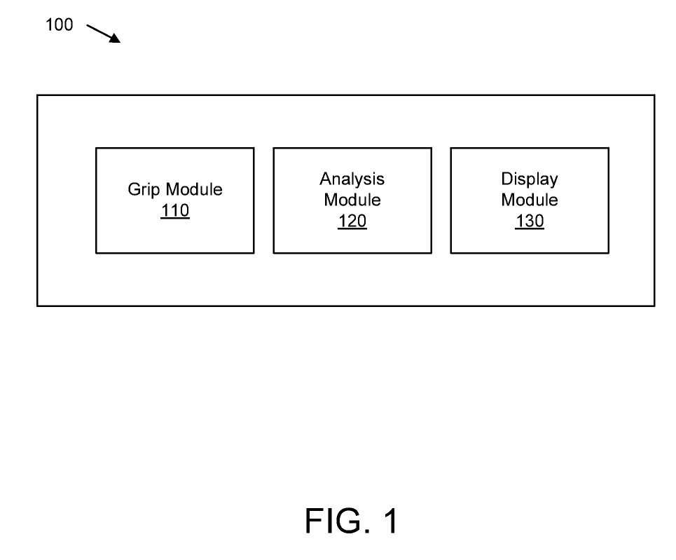

FIG. 1 is a schematic block diagram illustrating one embodiment of an apparatus for adjusting a display based on a brace of a computing device. In one embodiment, the apparatus may include a grip module 110, an analysis module 120 and a display module 130.

In one embodiment, a grip module 110 may be configured to detect a brace status. For example, a grip module 110 may detect that the apparatus is being braced by a user, based on detected fingers or thumbs at the screen via a touch sensor. In another embodiment, a grip module 110 may detect that the apparatus is currently not being braced. For example, a grip module may not detect any fingers, or the like, via the touch sensor. In one embodiment, the grip module 110 may detect that the computing device is resting on top of a structure. For example, the grip module 110 may detect that the computing device is resting on a table, a desk, a floor, or the like.

A brace as described herein, may mean at least interacting with the computing device so as to cause one or more sensors to detect a brace. In some embodiment, a touch may include physically contacting a touch sensor of the computing device. For example, a resistive touch sensor may detect a touch after a finger pressed on the resistive touch sensor. In another embodiment, a touch may include coming close to the touch sensor, but not physically contacting the touch sensor. For example, a capacitive touch sensor may detect a touch if a finger comes close enough to the capacitive touch sensor to affect the capacitance of the touch sensor. In another example, a touch sensor that includes a magnetic resonance pen, may detect a disturbance in a magnetic field based on a specialized pen coming close to a magnetic resonance touch sensor. Therefore, a “touch” a described herein, is not limited to any kind of physical contact, and any spatial proximity that affects a touch sensor of any kind may be considered a touch, even if from some distance away from the computing device.

As described herein, a touch sensor may include a variety of different touch technologies. A touch sensor may include resistive technologies such as two electrically-resistive layers separated by a thin space. A touch may be sensed by applying a voltage to one of the layers and detecting a voltage change when a portion of one of the layers comes in contact with the other layer based on the layer being physically moved.

A touch sensor may include surface acoustic wave technologies that may use ultrasonic saves that pass over a screen. A physical object approaching the screen may obstruct or absorb a portion of the ultrasonic wave. A change in the ultrasonic wave may be detected by the touch sensor.

A touch sensor may include capacitive touch technologies such as a panel of glass coated with a transparent conductor. A capacitive touch sensor may detect a distortion of an electrostatic field based on a change in capacitance. A capacitive touch sensor may not detect a touch by a physical object that is an electrical insulator. A capacitive touch sensor may be based on capacitive coupling, surface capacitance, projected capacitance, mutual capacitance, self-capacitance, or the like.

A touch sensor may include an infrared grid using an array of infrared LED's and photodetector pairs on the edges of a screen. A touch sensor may include infrared acrylic projection, optical imaging, dispersive signal technology, acoustic pulse recognition, or the like.

In one embodiment, the grip module 110 may detect that the computing device is being supported by a clip or stand. For example, a grip module 110 may detect four small touches near the corners of the computing device. In another embodiment, the grip module 110 may detect that the computing device may be set upright via a stand. For example, the computing device may include a tablet computer in tent mode. Tent mode may include the computing device resting on its long edge, leaning against a support structure, as one skilled in the art may appreciate. In one embodiment, the grip module 110 may detect that the computing device is laying down flat, substantially, vertical, substantially horizontal, rotated, or the like. In another embodiment, the grip module 110 may detect that a brace has been released from the computing device.

In one embodiment, a grip module 110 may be configured to detect a brace status. For example, a brace status may include, no brace, four fingers at a top edge of the computing device, thumbs on opposing sides of a computing device, the computing device on a stand, the computing device lying flat on a surface, the computing device substantially vertical, or other, or the like. Opposing sides may include a left edge and a right edge of the computing device. In another embodiment, a brace status may include the computing device being gripped by a user. In one embodiment, a brace status may include the computing device being grasped by a user or by some other device. Therefore, a brace status may include any means that provide for some physical support, any means that maintains or alters a position of the computing device, or the like.

In other embodiment, a grip module 110 may receive input from a motion sensor. In one embodiment, a motion sensor may include passive or active infrared, optical input, radio frequency energy, acoustic sensors, vibration sensors, accelerometers, magnetic sensors, or the like. In another embodiment, a grip module 110 may detect a single finger brace at a corner of a screen for the computing device, in combination with a motion sensor indicating the computing device is being moved upwards. Therefore, a grip module 110 may consider multiple different sensor types to detect if the computing device is currently being braced.

In another embodiment, a grip module 110 may receive input from an orientation sensor such as, but not limited to, an accelerometer, a gyroscope, or the like. In another embodiment, a grip module 110 may detect a brace status including no brace in combination with input from an orientation sensor to determine that the computing device is in a specific physical orientation. For example, a grip module 110 may detect that the computing device is in tent mode, or is laying flat. Therefore, a grip module 110 may consider one or many different sensor types to detect if the computing device is currently being braced, gripped, held, supported, maintained, moved, spun, or the like.

In one embodiment, a grip module 110 may receive input form an audio sensor, such as a microphone, or the like. In another embodiment, a grip module 110 may receive audio information digitally. A grip module 110 may include audio information in the brace status. In one example, audio information may include a verbal command by a user. A verbal command may specifically indicate a brace status.

In another embodiment, a grip module 110 may receive input from another module, such as a display module 130. For example, a user may select an icon at the display and the display module 130 may transmit a command to the grip module 110. Therefore, a brace status may also include a command from another module. In another example, an application executing on the computing device may command a grip module 110 to report a brace status that may not accurately reflect an actual brace status.

In other embodiments, a grip module 110 may receive input from a gesture sensor, or similar. A grip module 110 may include gesture information in the brace status. In one example, a gesture may include a hand waving over the screen. In response to this gesture, a grip module 110 may report a brace status associated with the gesture.

In one embodiment, the apparatus includes an analysis module 120. An analysis module 120 may be configured to determine if the brace status matches a brace pattern. For example, a grip module 110 may detect that a computing device is being held by two hands based on detecting thumbs on opposing sides of the display. An analysis module 120 may determine that the detected brace status matches a brace pattern. For example, a brace pattern may include holding the computing device with two hands with the thumbs touching opposing sides of the screen.

In another embodiment, a grip module 110 may detect a brace status including a single touch at one corner of a screen, wherein there is no additional input from a motion sensor, or an orientation sensor. In response to the grip module 110 detecting this brace status, an analysis module 120 may determine that the current brace status does not match a brace pattern because there is no brace pattern that includes a single touch in one corner of a screen. Therefore, the analysis module 120 may fail to determine that a current brace status matches a brace pattern.

In another embodiment, an analysis module 120 may receive a brace status that includes a verbal command. An analysis module 120 may override other aspect of the brace status based on the verbal command. For example, a verbal command may override touch information, motion information, orientation information, or the like.

In one embodiment, a touch sensor may fail resulting in a persistent input regarding a perceived detected touch. An analysis module 120 may determine that the persistent touch results from a faulty touch sensor. An analysis module 120 may generate new brace patterns incorporating the persistent touch, or may alter current brace patterns based on the persistent touch.

In one embodiment, a computing device may include a display module 130 configured to alter a portion of the screen used for display based on the determined brace pattern. In one example, the detected brace pattern may include two thumbs on opposing sides of the computing device. In response to this detected brace pattern, a display module 130 may decrease a portion of the screen used for display. This may create an artificial bezel, or a virtual bezel on opposing sides of the screen. In this way, a user of the computing device may brace the computing device, and still have access to a complete display, because they display had been decreased to accommodate the current brace pattern. In another example, a display module 130 may alter an aspect ratio of the display, based on a new portion of the screen being used for display.

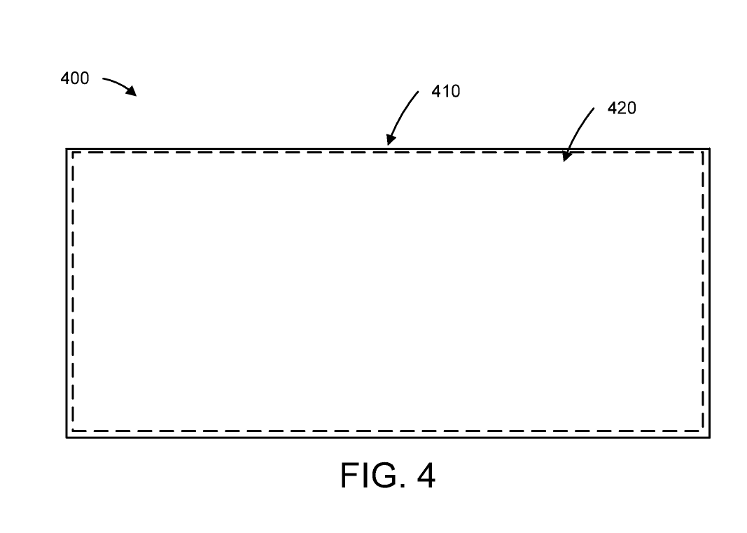

In another embodiment, a grip module 110 may detect a brace status that a computing device is no longer being braced. For example, a grip module 110 may no longer detect thumbs on opposing sides of the screen. In one embodiment, a displayable portion of the screen may be expanded to substantially include the entire screen. Such a configuration is depicted in FIG. 4.

In one embodiment, a brace status may not match a brace pattern. Therefore, a display module 130 may not alter a portion of the screen used for display, even if a brace has been detected, because the detected brace did not match a brace pattern. In another embodiment, a persistent touch may be detected by a grip module 110. If the persistent touch is integrated into the current brace patterns by the analysis module 120, the display module 130 may alter a portion of the screen used for display, based on a faulty touch sensor. Therefore, regardless of a broken touch sensor, a user may still operate and access the full features of a computing device, although using a more limited display.

In one embodiment, an analysis module 120 may receive brace patterns. A brace pattern for a brace may include location, duration, diameter, shape, pressure, or the like. Brace patterns may include different patterns for male users versus female users. Brace patterns may include statistical touches measured on other computing devices, or the like. A brace pattern may distinguish between a finger touch and a palm rest.

In another embodiment, an analysis module 120 may tune brace patterns based on historical usage of the computing device. For example, a detected brace that substantially matches a brace pattern, but does not meet a matching threshold may not trigger a display module 130 to alter a displayable portion of a screen. An analysis module 120 may adjust the brace pattern so as to be consistent with historical usage of the computing device.

In one embodiment, the brace patterns may include horizontal patterns or vertical patterns. An analysis module 120 may not distinguish between a horizontal brace pattern or a vertical brace pattern. Therefore, a brace status detected in a horizontal position may still match a brace pattern that is oriented vertically. In another embodiment, an analysis module 120 may distinguish between a finger touch and a palm rest, as one skilled in the art may appreciate.

In one example, a brace pattern may include many small touches around the outside of a screen. Many small touches may be from a cover, protector, or other device that may latch around the outside of a computing device. Therefore, in one example, an analysis module 120 may match a brace status with a brace pattern and command a display module to slightly decrease a displayable portion of the display, based on the size of the small touches around the outside of a screen.

In one embodiment, a computing device may include a square screen. In this embodiment, regardless of the orientation (or brace status) of the computing device, a display module 130 may adjust a displayable portion of the screen, based on the brace status. For example, if the computing device is set on one edge, a display module 130 may rotate the display so as to accommodate the orientation of the computing device. Therefore, a user of such a computing device does not need to know which edge of the computing device is the top, bottom, left side, right side, or the like. The computing device may simply be set down on any edge, and a display module 130 may rotate the display accordingly.

In one embodiment, a cover may be used to protect the screen. The display module 130 may include a sensor to determine if the screen is being covered. In one example, the cover may include a metal plate. A computing device may include a sensor to detect the metal plate. In response to a cover covering the screen, a display module 130 may disable the screen.

In another embodiment, a cover may include a magnet, and a computing device may include a hall effect sensor. The hall effect sensor may output a voltage in response to a magnetic field generated by a magnet in the cover. Therefore, a display module 130 may detect a cover and disable the screen in response to the detected cover. In another example, a display module 130 may stop an application on the computing device in response to detecting a cover. For example, the computing device may be playing a movie. In response to detecting a cover for the computing device, the display module 130 may stop playing the movie.

In another embodiment, a cover may not include a metal plate or magnet. However, a grip module 110 may detect a brace status that includes a large portion of the screen being touched. In one embodiment, in response to a grip module 110 detecting a brace status that includes a large portion of the screen being touched, an analysis module 120 may determine that the large touch matches a brace pattern. The display module 130 may disable the screen. For example, if the grip module 110 detects that 30% of the screen is being touched, an analysis module 120 may determine that the large touch matches a brace pattern, and the display module 130 may disable the display, or stop an application, as previously described.

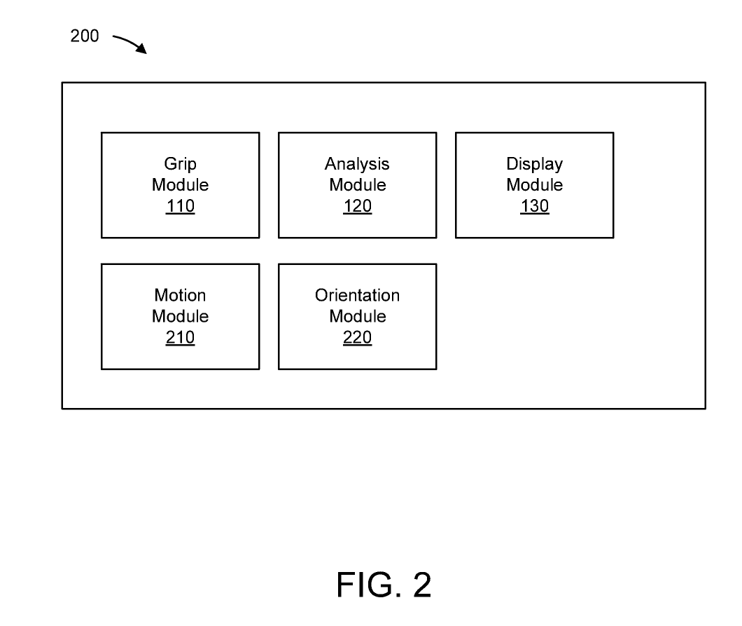

FIG. 2 is another schematic block diagram illustrating one embodiment of an apparatus 200 for adjusting a display based on a brace of a computing device. In one embodiment, an apparatus 200 may include a grip module 110, an analysis module 120, a display module 130, a motion module 210, and an orientation module 220. The grip module 110, the analysis module 120 and the display module 130 may or may not be substantially similar to the modules recited regarding FIG. 1.

An apparatus 200 may include a motion module 210. In one embodiment, a motion module 210 may be configured to detect a motion of the apparatus. In another embodiment, the grip module 110 may be further configured to detect a brace status based on the detected motion.

In one embodiment, a grip module 110 may receive input form a motion module 210. A motion module 210 may determine that the apparatus 200 is experiencing consistent motion. In one example, a user may be using the apparatus 200. A display module 130 may decrease the size of the display based on the consistent motion.

In one embodiment, a motion module 210 may differentiate between motion of the apparatus 200 by a user, and short bursts of motion that may be associated with riding in a car, or similar. In response to the motion module 210 detecting longer bursts of motion (such as by a user moving the device from one location to another), the display module 130 may decrease the size of the display. In another embodiment, a motion module 210 may detect vibrations, or short bursts of motion (such as by riding in a car, train, or the like), and the display module 130 may increase the size of the display if no touches are detected by the grip module 110. A grip module 110 may consider brace information from a touch sensor in combination with a motion module 210 in order to detect a brace status.

An apparatus 200 may include an orientation module 220. In one embodiment, an orientation module 220 may be configured to detect an orientation of the apparatus. In another embodiment, the grip module 110 may be further configured to detect a brace status based on the detected orientation.

In one embodiment, a grip module 110 may receive input from an orientation module 220. An orientation module 220 may be configured to detect an orientation of the apparatus, and the grip module 110 further configured to detect a brace status based on the detected orientation.

An orientation module 220 may determine that the apparatus 200 is experiencing a change in orientation. In one example, a user may be using the apparatus 200. An analysis module 120 may determine that the detected change in orientation may indicate that a user is using the apparatus 200 (i.e. walking around with the apparatus). A display module 130 may decrease the size of the display based on the detected orientation.

In one embodiment, a grip module 110 may receive a threshold rate of change for orientation. A grip module 110 may ignore a change in orientation if it falls below the threshold rate of change. This may allow an analysis module 120 to ignore a change in orientation, for example, if a user of the apparatus 200 is riding in a car that is currently turning. An analysis module 120 may determine that an orientation rate of change exceeds a threshold rate of change.

In one embodiment, a motion module 210 may differentiate between motion of the apparatus 200 by a user, and short burst of motion (or vibrations) that may be associated with riding in a car, or similar. In response to the motion module 210 detecting longer bursts of motion (such as by a user moving the device from one location to another), the display module 130 may decrease the size of the display. In another embodiment, a motion module 210 may detect that short bursts of motion (such as by riding in a car, train, or the like), and the display module 130 may increase the size of the display. A grip module 110 may consider brace information from a touch sensor in combination with a motion module 210 in order to detect a brace status.

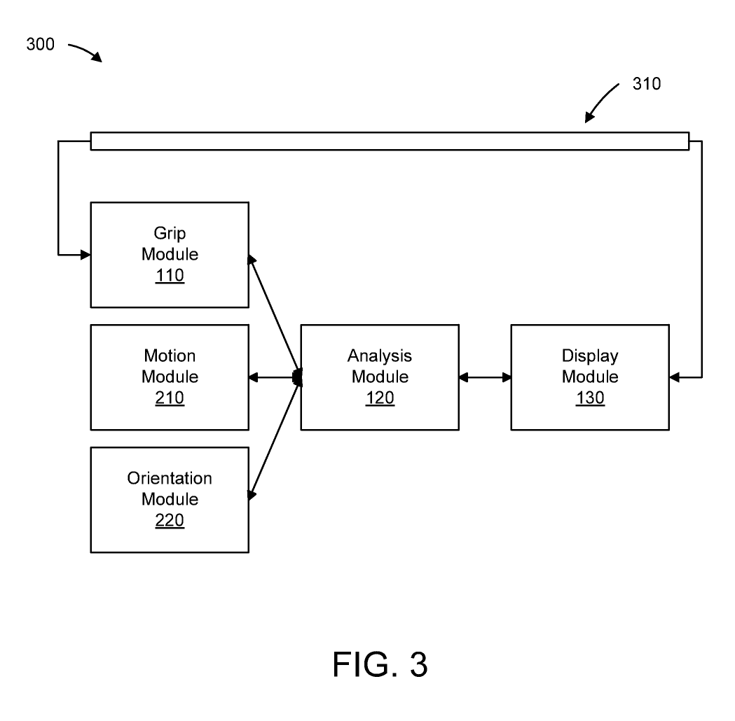

FIG. 3 is a schematic block diagram illustrating one embodiment 300 of a system for adjusting a display based on a brace of a computing device. In one embodiment, the system may include a screen 310, a grip module 110, a motion module 210, an orientation module 220, an analysis module 120, and a display module 120. The grip module 110, the motion module 210 the orientation module 220, the analysis module 120 and the display module 120 may or may not be substantially similar to respective modules described in earlier FIGS. 1 and 2.

In one embodiment, an apparatus may include a screen 310. A screen 310 may include a wide variety of display technologies including, but not limited to, digital light processing, cathode ray tube, liquid crystal, plasma, light emitting diode, organic light emitting diode, or other, or the like, as one skilled in the art may appreciate.

In one embodiment, the system may include a processor for executing instructions stored in a memory of the system. The system may include a grip module 110 configured to detect a brace pattern. In another embodiment, the system 300 may include a screen 310 according any of the previously described display technologies. In a further embodiment, the system 300 may include an analysis module 120 configured to determine if the brace status matches a brace pattern. In one embodiment, the system may include a display module 130 configured to alter a portion of the screen used for display based on the determined brace pattern.

In one embodiment, the display module 130 may alter a portion of the screen used for display at a hardware level such that an operating system, or other executing applications may not be aware of the change. Therefore, an operating system, or an executing application may continue displaying without considering the portion of screen that is currently being used for display. In another embodiment, a display module 130 may reside between an operating system and a display driver. Therefore, in some embodiments, a display module 130 may notify a display driver of the change, and the display driver may display current applications in the altered portion of the screen.

In one embodiment, the system 300 may include an analysis module 120 configured to receive input from a grip module 110, a motion module 210, and an orientation module 220. In another embodiment, an analysis module 120 may receive input from any one of the modules, all of the listed modules, or any subset of the listed modules, or other modules, or similar modules.

In one embodiment, a grip module 110 may detect a brace pattern indicating a brace at opposing edges of a computing device. An analysis module 120 may determine that the touch matches a brace pattern, and a display module 130 may adjust a displayable portion of the screen used for display by creating an artificial bezel on the edges being touched. In one example, artificial bezels may be created by displaying black areas near the edges being touched, and decreasing the displayable portion of the screen to be inside the black areas. In response to the brace being released, the display module 130 may remove the artificial bezel and allow the computing device to use the entire displayable screen as the current display.

In another embodiment, a virtual bezel may be created by a display module 130 creating black rectangles encompassing each edge of the screen. In another embodiment, the virtual bezel may be in another color, of may be configured to use a user provided image, or the like. Therefore, the actual image or colors displaying on the virtual bezel is not limited to any specific color or image.

FIG. 4 is an illustration depicting one embodiment 400 of a display 420. One embodiment may include a hardware screen 410, wherein the displayable portion 420 of the screen 410 substantially spans the entire screen 410. As previously described, in response to a brace, a display module 130 may decrease the size of a displayable portion 420 of the screen 410. In another embodiment, in response to a brace status of released, the display module 130 may increase the size of the displayable portion 420 of the screen 410 so as to substantially use the entire screen 410. In another embodiment, a display module 130 may adjust an aspect ratio of the display 420 based, at least in part, on the displayable portion 420 of the screen 410.

In one embodiment, after a display module 130 increases the displayable portion 420 of the screen 410, the displayable portion 420 may or may not be substantially similar to another displayable portion used before the display module 130 decreases a displayable portion of the screen.

In another embodiment, in response to a user releasing a brace on the computing device, a display module 130 may increase a displayable portion of the screen in order to accommodate a movie being played. Therefore, a larger displayable portion of the screen may or may not be substantially the same size as the physical screen 410.

In one embodiment, a manufacturer of a computing device according to the present disclosure may not manufacture bezels, and may make edges of the computing device as small as possible. In another embodiment, a computing device may not have any edges at all.

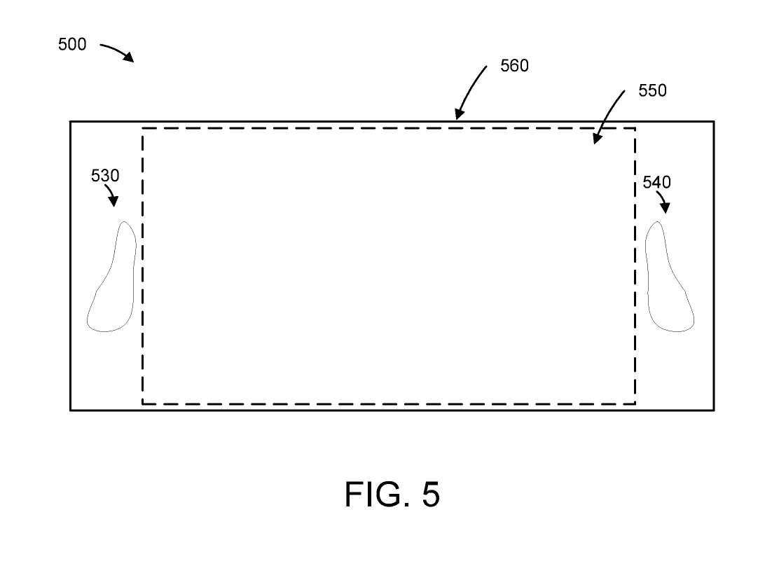

FIG. 5 is an illustration depicting one embodiment of a screen 560 after a displayable portion 550 of the screen 560 has been adjusted. In one example, a grip module 110 may detect a touch resembling a left thumb 530 on the left side of the screen, and may detect a touch resembling a right thumb 540 on a right side of the screen. A grip module 110 may report a brace status to an analysis module 120 that includes the two detected thumbs 530,540 on opposing sides of a screen 560. An analysis module 120 may determine that the two detected thumbs matches a brace pattern of being “left/right braced.” A display module 130 may adjust a displayable portion of the screen 560 by decreasing the displayable portion 550 of the screen as depicted in FIG. 5. In another embodiment, a display module 130 may generate a color or image to fill unused portions of the screen 560. In another embodiment, a user may provide a color or image to be used to create an artificial or virtual bezel for the computing device.

In one embodiment, a display module 130 may adjust the displayable portion 550 of the screen 560 uniformly, or the smaller portion 550 substantially centered on the screen 560. In other embodiments, the display module 130 may adjust the displayable portion 550 to be more on the left side, or more on the right side, depending on the size, or magnitude, or location of the sensed touches. In another embodiment, a display module 130 may change the aspect ratio of the displayable portion 550 from 16:9 to 16:10, based on the decreased size of the displayable portion 550. In one embodiment, based on a decreased displayable portion 550 of the screen 560, a computing device may or may not detect touches of the screen in the areas of the screen that are not being currently used for display.

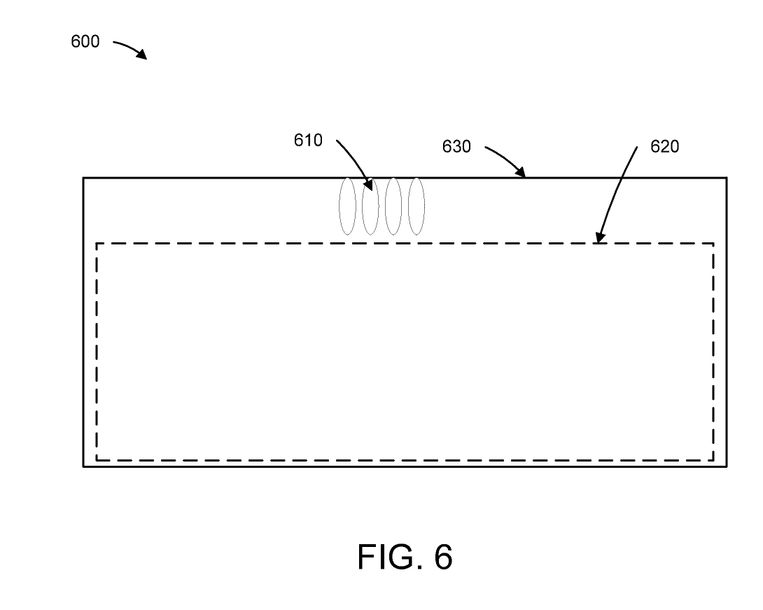

FIG. 6 is an illustration depicting one embodiment 600 of a display after adjustment.

In one example, a grip module 110 may detect a touch resembling a left thumb 530 on the left side of the screen, and may detect a touch resembling a right thumb 540 on a right side of the screen. A grip module 110 may report a brace status to an analysis module 120 that includes the two detected thumbs 530,540 on opposing sides of a screen 560. An analysis module 120 may determine that the two detected thumbs matches a brace pattern of being “left/right braced.” A display module 130 may adjust a displayable portion of the screen 560 by decreasing the displayable portion 550 of the screen as depicted in FIG. 5. In another embodiment, a display module 130 may generate a color or image to fill unused portions of the screen 560. In another embodiment, a user may provide a color or image to be used to create an artificial or virtual bezel for the computing device.

In one embodiment, a display module 130 may adjust the displayable portion 550 of the screen 560 uniformly, or the smaller portion 550 substantially centered on the screen 560. In other embodiments, the display module 130 may adjust the displayable portion 550 to be more on the left side, or more on the right side, depending on the size, or magnitude, or location of the sensed touches. In another embodiment, a display module 130 may change the aspect ratio of the displayable portion 550 from 16:9 to 16:10, based on the decreased size of the displayable portion 550. In one embodiment, based on a decreased displayable portion 550 of the screen 560, a computing device may or may not detect touches of the screen in the areas of the screen that are not being currently used for display.

In one example, a user may brace the computing device with four fingers touching a top edge of the screen 630. A user may brace the computing device while resting the device on his/her forearm, with the screen 630 facing upwards. In response to the detected brace pattern that includes four fingers 610 on one edge of the screen 630, a display module 130 may decrease a displayable portion 620 of the screen 630 so as to ensure that the display 620 is viewable by a user.

In another example, a user may face the computing device outwards, away from the user by braceping the computing device with a hand and having four fingers 610 over a top edge of the computing device. In response to the detected brace pattern that includes four fingers 610 on one edge of the screen 630, a display module 130 may decrease a displayable portion 620 of the screen 630 so as to ensure that the display 620 is viewable by other potential viewers of the computing device. In this way, a user of the device may not need to be aware of how much of the screen 630 his/her fingers 610 may be covering. The computing device, according to the present disclosure, may automatically adjust the displayable portion 620 of the screen 630 without requiring action by a user, other than to brace the device.

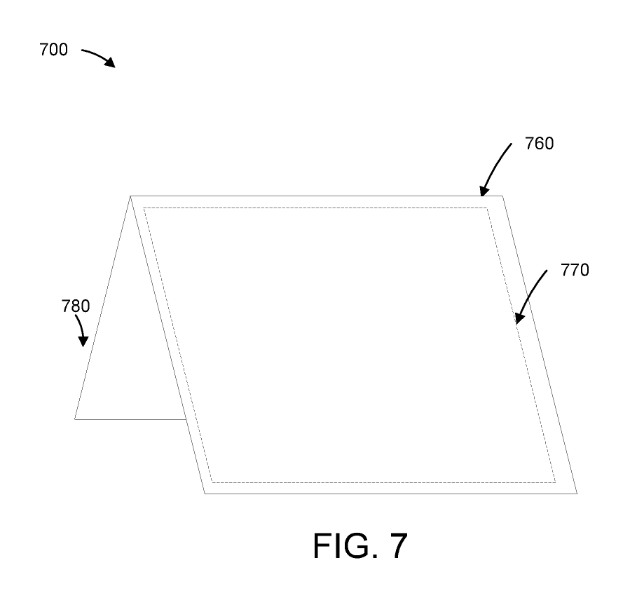

FIG. 7 is an illustration depicting one embodiment 700 of a device in tent mode. In one embodiment, a computing device 700 may be braced and a display module 130 may have decreased a displayable portion 770 of a screen 760, based on a current brace pattern. A computing device 700 may be placed on a surface, and supported against another object 780, wall, stand, or the like. The computing device 700 may detect a brace status of “tent mode.” Tent mode, may indicate that a touch sensor may not detect a touch on a screen 760, and an orientation module 220 may detect the device leaning at an angle between 45 and 90 degrees from parallel with the surface.

In response to an analysis module 120 matching a brace status of “tent mode” with a brace pattern of “tent mode,” a display module 130 may increase a displayable portion 770 of the screen 760 so as to substantially encompass the entire screen 760, or an entire displayable portion 770 of the screen 760. In one example, a user of the computing device 700 may set the computing device 700 on a table in order to present media information to other users. In another example, a user of the computing device 700 may set the computing device 700 on a desk, a user's lap, another structure, or the like, in order to watch a movie on the computing device. According to the present embodiment, a user may enjoy the movie using as much displayable portion 770 of the screen 760 as possible. In another embodiment, a display module 130 may alter an aspect ratio of the display 770 in order to optimize presentation of the movie.

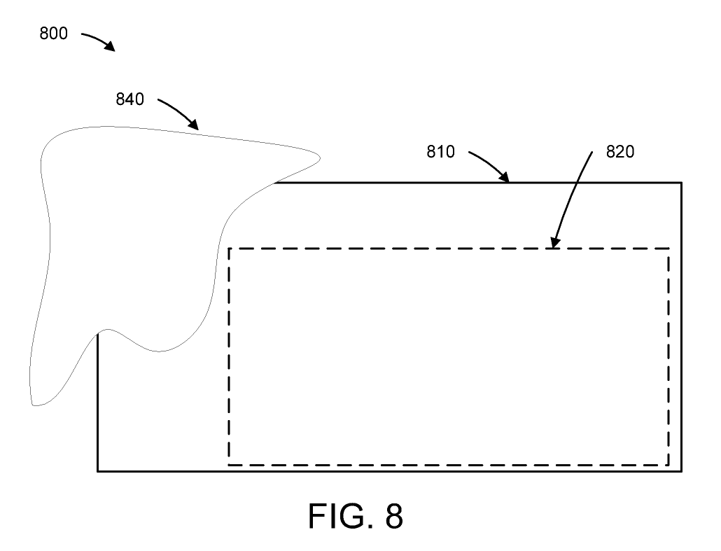

FIG. 8 is an illustration depicting one embodiment 800 of a computing device having a decreased displayable portion 820 of a screen. In one embodiment, a large object 840 may have been placed on the computing device 800, or may otherwise be detected by a touch sensor for a grip module 110 of the computing device. A grip module 110 may detect a brace status including “corner covered.” A brace status of “corner covered” may include a corner of a computing device 800 being touched by an object 840. In one embodiment, the object 840 covers a corner of the screen 810 such that substantially one corner of the screen is being covered. In one embodiment, a corner of the screen 810 may be covered which may cover 15% of the screen 810. In another embodiment, more than 15% of the screen is being covered. In another embodiment, less than 15% of the screen is being covered.

In response to an analysis module 120 matching a brace status of “corner covered” with a brace pattern of “corner covered,” a display module 130 may decrease a displayable portion 820 of the screen 810 so as allow the display 820 to be viewed by a user of the computing device 800 regarding of the present of the object 840. In one embodiment, the display module 130 may change an aspect ratio for the display 820 based on a decreased display 820 size. In one example, a book may be placed on the computing device 800 that covers a corner of the screen. Therefore, a display module 130 may alter a displayable portion 820 of the screen based on the detected book covering a corner of the screen 810.

In another embodiment, a grip module 110 may subsequently detect that the object 840 has been removed from a corner of the computing device 800. Therefore, a grip module 110 may detect a brace status of “released.” In response to a change in the brace status of the computing device 800, a display module 130 may increase a displayable portion 820 of the screen 810, so as to maximize an experience of a user of the computing device 800.

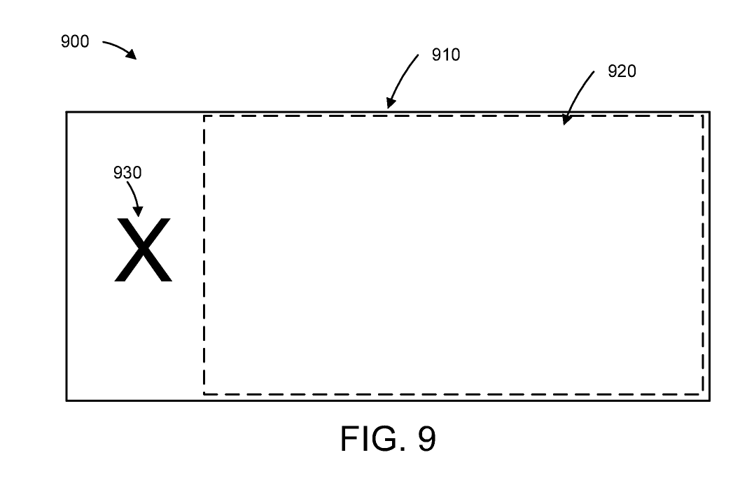

FIG. 9 is an illustration depicting one embodiment 900 of a computing device with a screen having been decreased in size. In one embodiment, a portion of a physical screen 910 may malfunction and a grip module 110 may detect a large persistent touch at the screen 910.

In one embodiment, a persistent touch may result from a broken or otherwise malfunctioning touch sensor. An analysis module 120 may determine that a persistent touch is persistent. In one embodiment, a persistent touch may mean that the touch is detected for a threshold period of time. In another embodiment, a persistent touch may mean that the touch is detected through several changes in brace patterns detected by the grip module 110.

In response to a persistent touch, an analysis module 120 may alter current brace patterns and analyze the brace patterns with respect to an adjusted screen 920. In another embodiment, the adjusted screen, may include a virtual screen. Therefore, a grip module 110 may detect a brace status based on a virtual screen 920, as opposed to a physical screen 910.

Therefore, in one embodiment, an analysis module 120 may determine that a brace status matches “movie mode,” and a display module 130 may increase the size of a displayable portion of the (virtual) screen 920, but may not increase the size of the displayable portion of the screen 920 to include the persistent touch area.

In one embodiment, an analysis module 120 may detect that the persistent touch has ceased. In this embodiment, an analysis module 120 may include an entire screen 910 in the analysis of brace patterns.

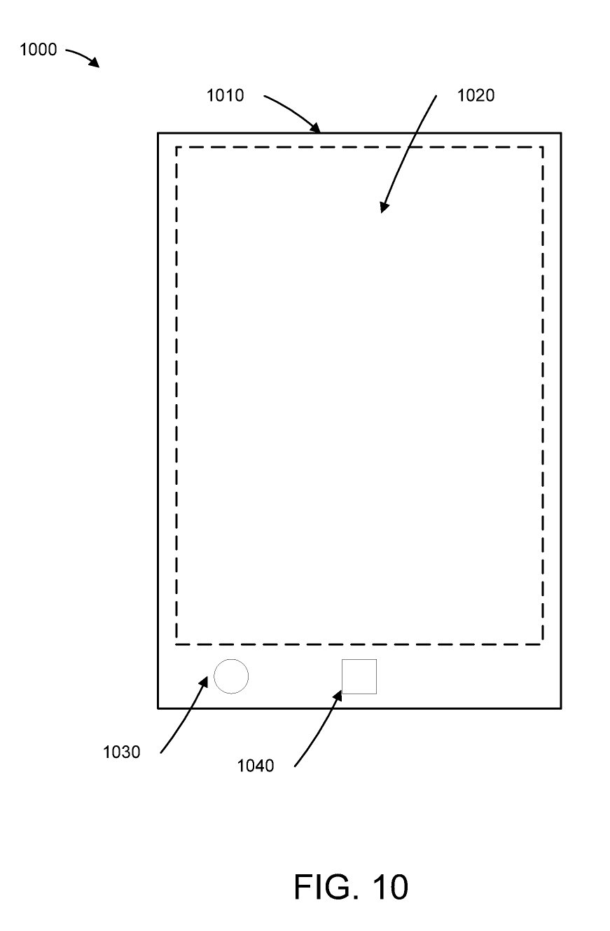

FIG. 10 is an illustration depicting one embodiment 1000 of a computing device 1010 including haptics 1030, 1040. In one embodiment, a screen 1020 for a computing device 1010 may not encompass an entire side of a device 1010. For example, the computing device may include haptics, such as, but not limited to, buttons 1040, a camera 1030, or other physical device, control, interface, or the like.

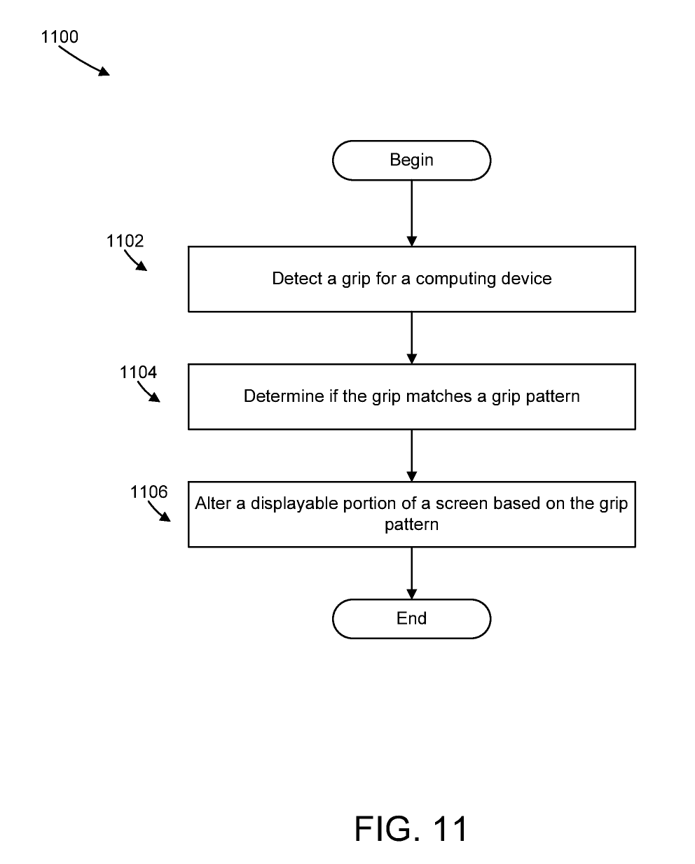

FIG. 11 is schematic flow chart diagram illustrating one embodiment of a method for adjusting a display based on a brace of a computing device. In one embodiment, the method 1100 may begin and a grip module 110 may detect 1102 a brace for a computing device. An analysis module 120 may determine 1104 if the brace matches a brace pattern. A display module 130 may alter 1106 a displayable portion of a screen based on the determined brace pattern.

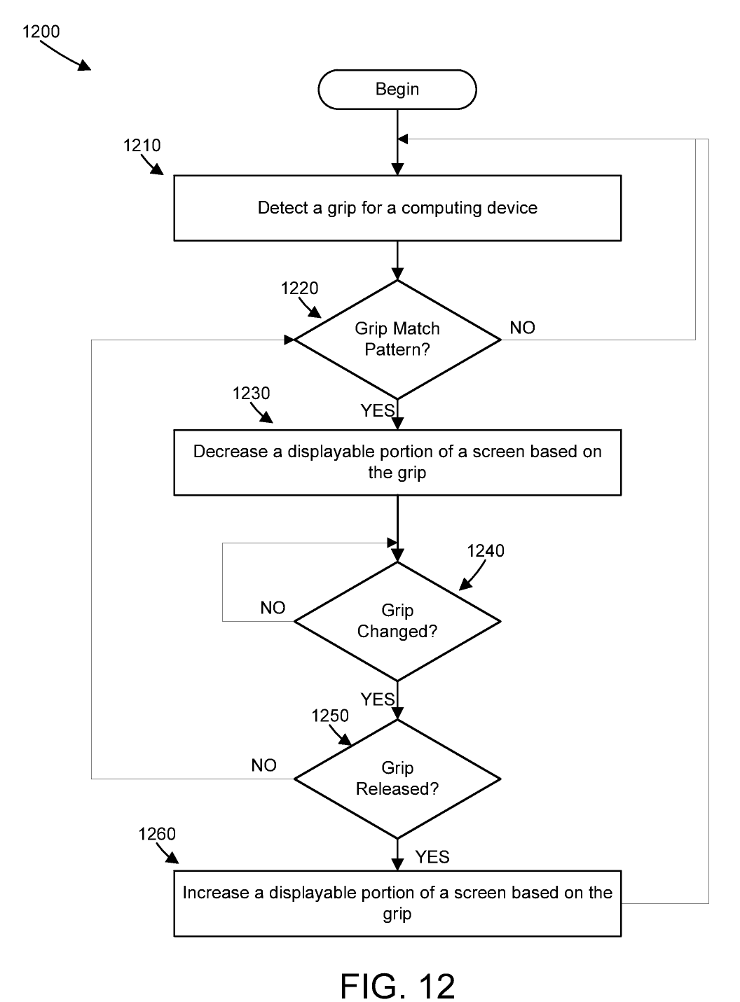

FIG. 12 is another schematic flow chart diagram illustrating one embodiment 1200 of a method for adjusting a display based on a brace of a computing device. In one embodiment, the method 1200 may begin and a grip module 110 may detect 1210 a brace for a computing device. An analysis module 120 may determine 1220 if the brace matches a brace pattern. If the detected brace does not match a brace pattern, the method may return to block 1210 where a grip module 110 may detect 1210 another brace, or a brace status, at a computing device.

If the detected brace does match a brace pattern, a display module 130 may decrease 1230 a displayable portion of a screen based on the detected brace. A grip module 110 may detect 1240 if a brace of the computing device has changed. If the brace for the computing device has not changed, a grip module 110 may continue to detect if a brace changes for the computing device. If the brace for the computing device has changed, an analysis module 120 may determine 1250 if the brace has been released for the computing device. If the brace has not been released, an analysis module 120 may proceed at block 1220 and determine 1220 if the brace matches a brace pattern. If the brace has been released, a display module 130 may increase 1260 a displayable portion of a screen based on the brace pattern.

What is claimed is:

1. An apparatus comprising:
a processor;
a screen operatively coupled to the processor;
a grip module configured to detect a brace status;
an analysis module configured to determine if the brace status matches a brace pattern; and
a display module configured to alter a portion of the screen used for display based on the determined brace pattern.

2. The apparatus of claim 1, further comprising a motion module, the motion module configured to detect a motion of the apparatus, the grip module further configured to detect a brace status based on the detected motion.

3. The apparatus of claim 1, further comprising an orientation module, the orientation module configured to detect an orientation of the apparatus, the grip module further configured to detect a brace status based on the detected orientation.

4. The apparatus of claim 1, wherein the brace status comprises a grip of the apparatus.

5. The apparatus of claim 1, wherein the brace status matches a plurality of brace patterns.

6. The apparatus of claim 1, wherein the brace status does not match a brace pattern, the display module further configured to increase the portion of the screen used for display, based on the brace status.

7. The apparatus of claim 6, wherein the display module alters the aspect ratio of the display, based on the portion of the screen used for display.

8. The apparatus of claim 1, wherein the brace status comprises a detected brace of the apparatus, the display module further configured to decrease a portion of the screen used for display, based on the brace status.

9. The apparatus of claim 8, wherein the display module adjusts the display to fit inside the determined brace pattern.

10. A method comprising:
detecting a brace of a computing device, the brace comprising touching a portion of the screen for the computing device;
determining if the brace matches one of a set of brace patterns; and
altering a displayable portion of a screen based on the matched brace pattern.

11. The method of claim 10, further comprising increasing a portion of a screen being used for display in response to determining that the screen is no longer being touched.

12. The method of claim 10, wherein the altering a displayable portion of the screen comprises decreasing the size of the display in response to a determined brace pattern, the display not using a portion of the screen that is being touched.

13. The method of claim 12, wherein the decreasing the size of the display comprises disabling a top portion of the screen and disabling a bottom portion of the screen.

14. The method of claim 10, wherein the altering further comprises altering a displayable portion of a screen based on a configuration parameter.

15. The method of claim 10, wherein detecting the brace comprises detecting one of a motion, or an orientation for the computing device, the determining comprising determining if the brace matches a brace pattern, based on one of the detected motion and the detected orientation.

16. A program product comprising a computer readable storage medium storing machine readable code executable by a processor to perform:
detecting a brace of a computing device, the brace comprising touching a portion of the screen for the computing device;
determining if the brace matches one of a set of brace patterns; and
altering a portion of a screen being used for display based on the matched brace pattern.

17. The computer program product of claim 16, wherein the executable code, when executed by the processor, further increases a portion of a screen being used for display in response to determining that the screen is no longer being touched.

18. The computer program product of claim 16, wherein the altering a portion of the screen comprises decreasing the size of the display to no longer use a portion of the screen that is being touched.

19. The computer program product of claim 16, wherein the altering a portion of the screen comprises disabling a top portion of the screen, disabling a bottom portion of the screen, and adjusting an aspect ratio for the display based on a usable portion of the screen.

20. The computer program product of claim 16, wherein the determining if the brace matches one of a set of brace patterns comprises detecting one of a motion or an orientation of the computing device.
